(19) United States
(12) Patent Application Publication
(10) Pub. No.: US 2001/0029481 A1
(43) Pub. Date: Oct. 11, 2001

(54) Transaction system

(76) Inventors: Donal Doherty, Shankill (IE); Christopher Simms, Dublin (IE); Joseph Brennan, Blackrock (IE)

Correspondence Address: BIRCH STEWART KOLASCH & BIRCH, PO BOX 747, FALLS CHURCH, VA, 22040-0747, US

(21) Appl. No.: 09/841,872

(22) Filed: Apr. 26, 2001

Related U.S. Application Data
(63) Continuation of application No. PCT/IE01/00014, filed on Feb. 1, 2001.

(30) Foreign Application Priority Data
Feb. 2, 2000 (IE) S2000/0104

(51) Int. Cl. G06F 17/60

(52) U.S. Cl. 705/37; 705/1

(57) ABSTRACT

A transaction system (10) in which a customer computer (12) can use a broker or host computer (14) in a communications network to obtain quotations for goods and services from merchant computers (12). The broker computer (14) carries out most of the transaction tasks on behalf of the customer. These can be conventional shopping for goods, factory procurement, wagering or even the reporting and retrieval of goods lost and/or found.

### FIELD OF THE INVENTION

The present invention relates to a method of carrying out a transaction in goods and/or services between a customer and a merchant in a trading system, such a trading system generally including a communications network connecting a plurality of merchant computers; a plurality of customer computers; and at least one broker computer. The invention relates in particular to a system for trading using wireless application technology.

Further, the invention is directed towards providing a broker computer, a customer computer and various computer programs for carrying out the methods and providing the means according to the invention.

Remote trading in the sense that the customer is not viewing goods or services directly but is buying the goods or services either from a catalogue, for example, through the mail or, as is becoming more and more the case, on the Internet or other communication links. As communications systems become more efficient, the amount of trading that will be carried out in this way will increase and indeed is already increasing exponentially. The growth of eCommerce is likely to change the way people buy goods and services. All one can say is that eCommerce is increasing at an exponential rate and all the signs are that it will continue to increase for the foreseeable future.

Further, the consumer, in a reversal of shopping trends over the last few decades, is availing of delivery services provided by supermarkets and other suppliers, which service is being actively promoted by supermarket operators to avoid store overcrowding, long check-out queues and customer dissatisfaction while promoting customer loyalty.

The term “trading” is used in this specification in the broadest sense, namely, for the obtaining of, distribution of, brokerage of, payment for and sale of goods and services as well as including the various transactions involved in and carrying out this “trading” where they are defined as described above. Thus, it includes shopping in the strict sense of the purchase of goods and services as well as other activities such as wagering, obtaining of quotations for supply of goods and services in industry, booking tickets for events, booking holidays, purchasing airline tickets and services such as “lost and found”.

In this specification, the term “computer” is used to encompass not just simply computers as we know them, but any device capable of storing and transmitting information such as a mobile phone with memory and indeed any other similar device.

The present invention is directed towards improving such methods of carrying out a transaction in goods and/or services between a customer and a merchant in such a trading system.

### SUMMARY OF THE INVENTION

According to the invention, there is provided a method of carrying out a transaction in goods and/or services between a customer and a merchant in a trading system including a communications network connecting a plurality of merchant computers; a plurality of customer computers; and at least one broker computer comprising the steps of:

the customer computer sending a list of preferred merchants to the broker computer;

the customer computer sending an initial trading request to the broker computer;

the broker computer sending the initial trading request to each merchant computer with a quotation request;

the merchant computer sending the quotation back to the broker computer;

the broker computer preparing a proposed trading request from the quotations for the preferred merchants; and

the broker computer downloading the proposed trading request to the customer.

Ideally, in this method:

the customer computer receives the proposed trading request;

the customer computer displays the proposed trading request;

the customer computer prepares a transaction list from the proposed trading request; and

the customer computer sends the relevant portion of the transaction list to the merchant computer.

Further, the method may comprise:

the customer computer receives the proposed trading request;

the customer computer displays the proposed trading request;

the customer computer prepares a transaction list from the proposed trading request;

the customer computer sends the transaction list to the broker computer; and

the broker computer transmits the relevant portion of the transaction list to the merchant computer.

Further, the method comprises, on the broker computer transmitting the transaction list to the merchant computer:

the merchant computer transmits acceptance of the order, delivery details and a payment request to the broker computer;

the broker computer confirms completion to the merchant computer; and

the broker computer confirms payment to the merchant computer.

In this latter method, in some situations, prior to confirming payment to the merchant computer, the broker computer confirms payment with the customer computer. Alternatively, prior to transmitting acceptance of the order, the broker computer transmits merchant computer acceptance, delivery and payment details to the customer computer and on receiving confirmation from the customer computer, transmits the acceptance to the merchant computer.

It is envisaged that in accordance with the invention, the customer computer, as a step independent of any downloading of a trading request, downloads the list of preferred merchants to the broker computer and the broker computer stores, in a merchant database, a list of preferred merchants for each customer computer. Ideally, the preferred merchants are stored in order of customer preference.

In one method according to the invention, the broker computer prepares the proposed trading request having regard to pre-established rules agreed with the customer.

Further, invention provides a broker computer in a trading system comprising a communications network connecting a plurality of merchant computers and a plurality of customer computers comprising:

means for receiving an initial trading request from a customer computer;

means for sending the initial trading request to one or more merchant computers with a quotation request;

means for receiving quotations from the merchant computer;

means for preparing a proposed trading request from the quotations; and

means for downloading the proposed trading request to the customer computer.

In one embodiment of the invention, the broker computer comprises:

means for receiving a transaction list from a customer computer; and

means for using the transaction list to complete the transaction with the merchant computer for the customer computer.

Further, the broker computer may comprise:

means for storing in a merchant database, a list of preferred merchants for each customer;

means for retrieving the list of preferred merchants on receiving the initial trading request; and

means for sending the quotation request to the preferred merchant computers.

Further, the invention provides a customer computer for use in a trading system comprising a communications network connecting a broker computer and a plurality of merchant computers comprising:

means for downloading an initial trading request to the broker computer with a quotation request;

means, on receiving the quotation request as a proposed trading request from the broker computer, to prepare a transaction list;

means for sending the transaction list to the broker computer; and

means for completing the transaction.

In one embodiment, the means for completing the transaction includes means for confirming payment with the merchant computer and may include means for confirming payment with the broker computer.

Further, the invention provides a computer comprising program instructions for causing a computer to carry out the functions of the broker computer in the method as laid out above. Further, the invention provides a computer program comprising program instructions for causing a computer to carry out the functions of the customer computer in the method as described above.

Further, the invention comprises a computer program comprising program instructions which when loaded into a computer constitute the means as described above. Any computer program according to the invention may be embodied in a record medium, a computer memory, a read only memory, and/or an electrical carrier signal.

### BRIEF DESCRIPTION OF THE DRAWINGS

The invention will be more clearly understood from the following description of an embodiment and a method thereof, given by way of example only, with reference to the accompanying drawings and flowcharts in which:

FIG. 1 is an outline of a trading system according to the invention,

FIGS. 2 to 4 are flow diagrams illustrating one method of carrying out the invention, and

FIGS. 5 to 8 are other flow diagrams of methods according to the invention.

### DETAILED DESCRIPTION OF THE PREFERRED EMBODIMENTS

Before describing the system and the method of carrying out the invention, it should be noted that, to a certain extent, there is some overlap in the description between “customer” and “customer computer”, “merchant” and “merchant computer”, as well as “broker” and “broker computer”. It would have caused considerable confusion to have tried to separate them and thus the terms are used substantially interchangeably. However, the invention is carried out by the use of such computers as hereinbefore defined. It is, for example, envisaged that a mobile phone might be used as the customer computer but is unlikely to be used as such for the merchant computer.

The essential feature of the invention is that the main parties in the transaction are generally physically remote from each other. While it is possible that a broker and merchant might be in the one organisation, almost certainly the customer will be generally some considerable distance from the merchant.

Further, the system does not rely on utilising wireless applications protocol nor is it akin to shopping systems such as are prevalent in supermarkets with customers downloading item details as they shop.

Effectively, it is a system where a broker acts as a service provider to the customer carrying out instructions from the customer to facilitate the engagement of third parties, herein merchants for the performance of tasks, i.e. the supply of goods and services to the customer.

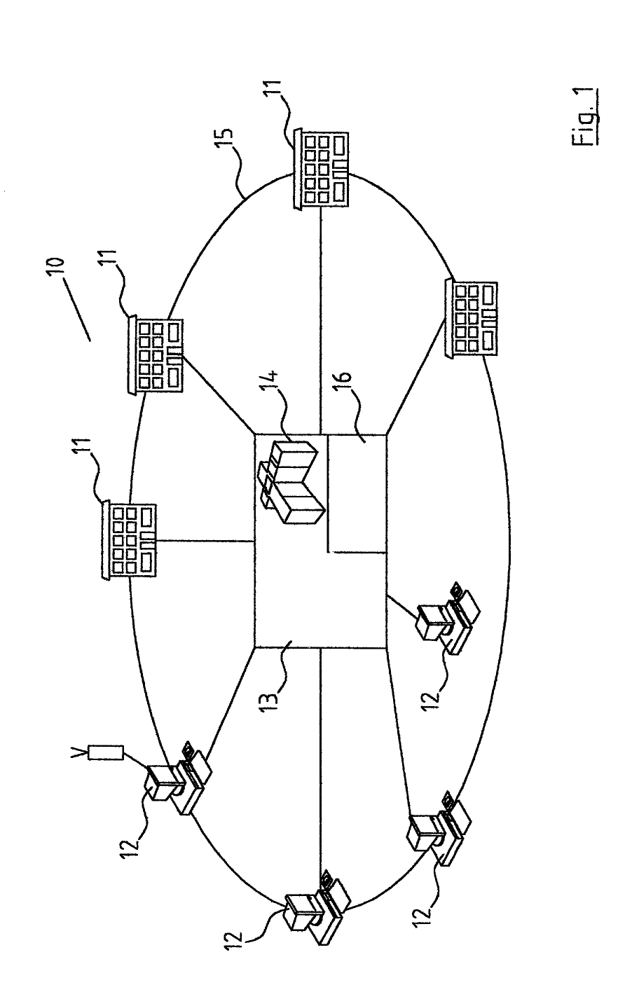

Referring to FIG. 1, there is illustrated a trading system indicated generally by the reference numeral 10 having a plurality of merchant computers 11, customer computers 12 and a broker computer 14 within a site 13. All of these are connected by a communications network 15. A merchant database 16 is provided for the broker computer 14. The trading system is now described for a straightforward exercise, namely, the purchase of goods.

In operation, a customer will prepare an initial shopping list and will load it onto the customer computer 12. The customer computer 12 will then transmit the initial more properly trading shopping list to the site 13 and the broker computer 14. While in this embodiment, shopping list is the correct term to use, a more general term to cover all trading and transaction situations between two entities, one requiring something—the customer, and one supplying something—the merchant, is trading request. The broker computer 14 will then obtain quotations from the various merchant computers 11 having regard to the initial trading request downloaded. Almost certainly, prior to preparing the trading request, the customer computer 12 will have downloaded to the broker computer 14, a plurality of preferred merchants that the customer wishes to deal with. The broker will have already listed these onto the preferred merchant database 16 and thus when the broker computer 14 receives the initial trading request, the broker computer 14 automatically consults the preferred merchant database 16 and a list of preferred merchants is obtained which list of preferred merchants is then used to contact the merchant computers 11. On receipt of the various quotations, the merchant computer automatically prepares a proposed trading request, which trading request is then downloaded to the customer computer 12 and the customer computer 12 then prepares a shopping basket from the proposed trading request. Again, a more general term would be “transaction list” to cover situations where other activities are encompassed. The transaction list is then transmitted to the broker computer 14 and the broker computer 14 contacts one or more of the merchant computer 11 and completes the trade on behalf of the customer computer. It will be appreciated that the broker computer 14 may provide more than one quotation to the customer.

As suggested already, this shopping list or trading request can relate to any product or service for example the list may be a retailing, purchasing or manufacturing service, music, gambling or any financial service, but not limited to such. The trading request can be easily generated by the customer computer. However, the trading request can be generated by a communication device having a scanner and this is the subject of a separate co-pending patent application. Having obtained the quotation nearest to the customers requirements, the broker will then transmit the trading request back to the customer who may then use the trading request to prepare a required transaction specification which, with goods is a transaction list, to transmit either directly to a merchant or back to the broker for the broker to place the necessary order with the merchants. Needless to say, the customer and broker can agree suitable rules so that, in certain circumstances, the broker may in fact pay the merchant and complete the transaction with the merchant, while in other circumstances, the payment may be carried out directly between the customer computer and the merchant computer. This is really a matter of preference. There are, however, certain great advantages for the customer computer only dealing with the broker computer in the sense that all the problems of card-not-present fraud are eliminated if the only party who has, for example, a customers credit card number, is the broker computer.

The broker computer is in effect a host computer to provide numerous services to the customer.

Ideally, the site will include dynamic brokering software which allows sellers to bid electronically for purchases according to user defined criteria. Thus, for example, dealing purely with supermarket shopping, a number of supermarkets would be subscribers to the site. Then, the data produced by the customer is transmitted to the site and thus, for example, a customer in a particular area might request to be give a quotation for a transaction list and whichever retailer or merchant provides the lowest quotation, then the customers requests either the broker or the merchant to supply the goods.

It will be appreciated that this system can be used on any internet based system or application. It will also be appreciated that this site does not necessarily have to be a web site, it is merely a software application that can be used by phone-based units and accessed via the Internet.

It will be appreciated that anything from ticketing, gambling, various quotations for purchase of, for example, stocks, traffic news, games, calendars, weather, voice mail, Email, banking and so on, can all be provided within the one site.

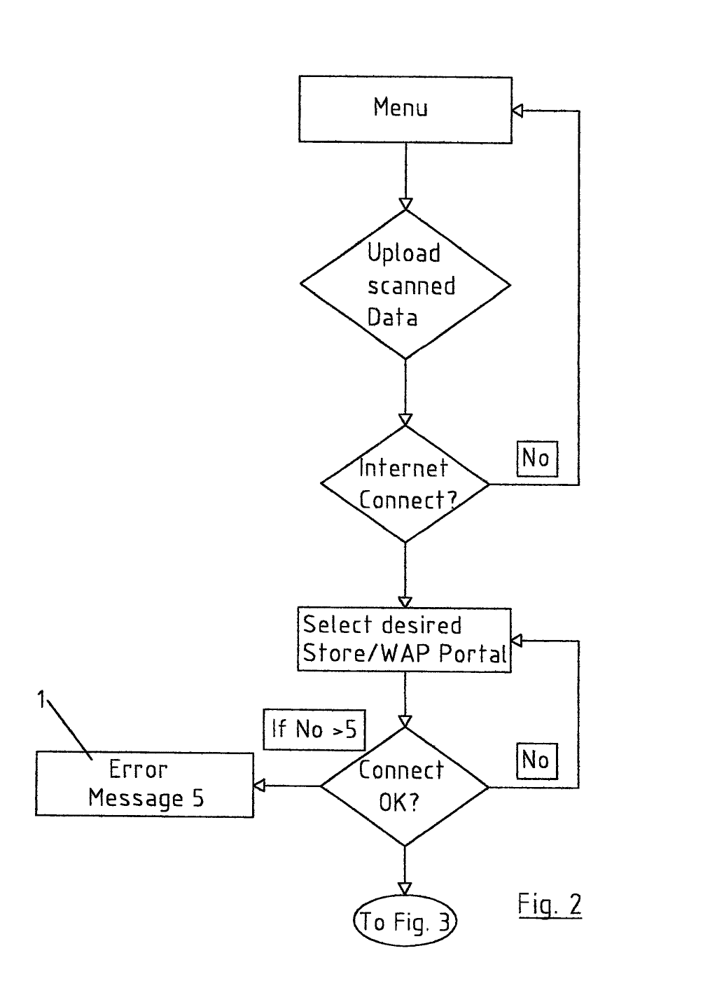

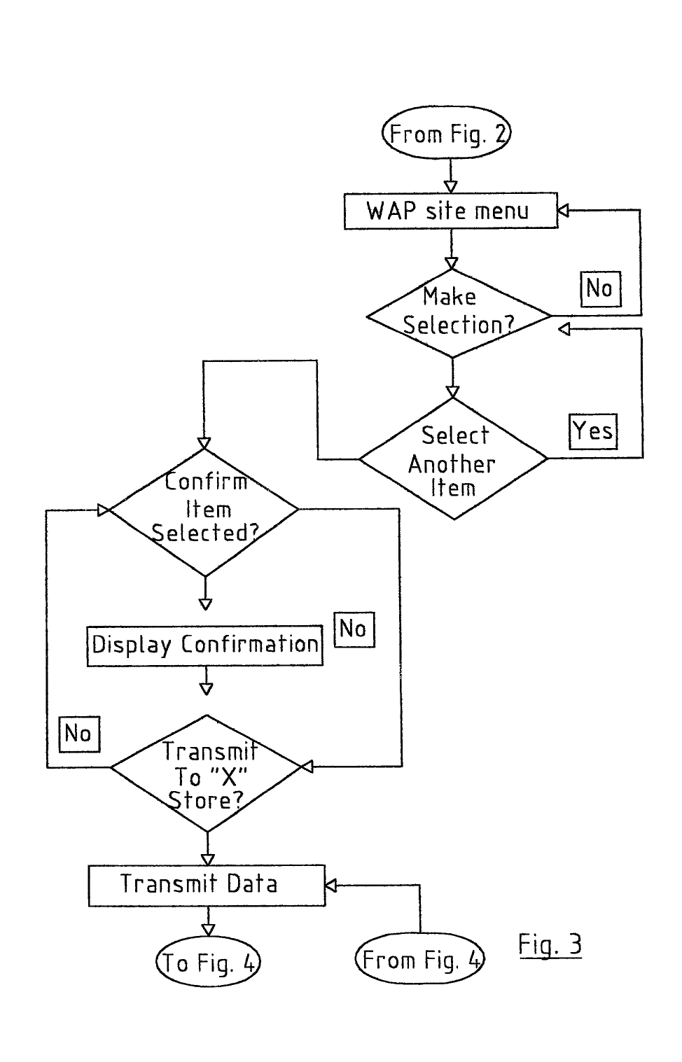

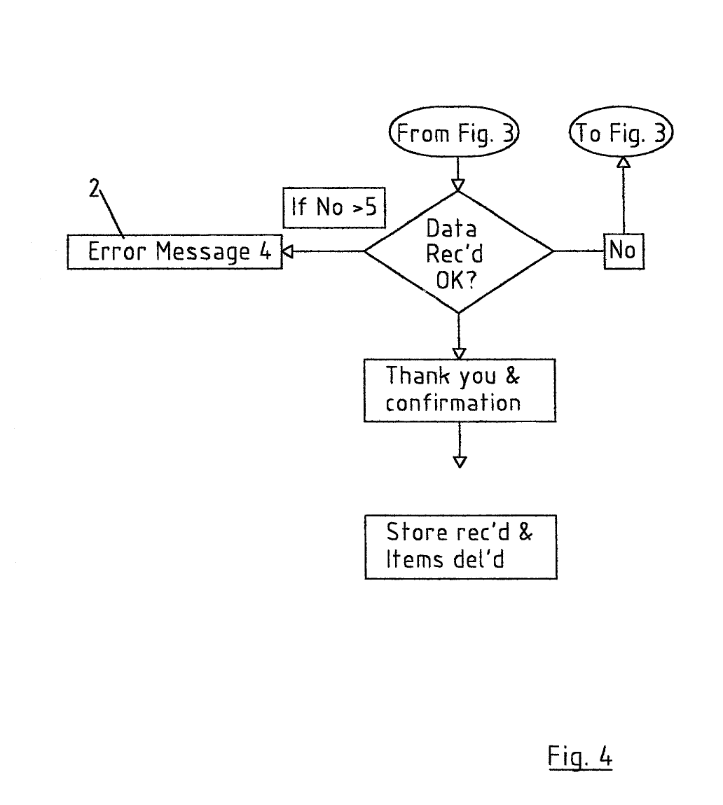

The flowchart of FIGS. 2 to 5 illustrates one system of purchasing according to the invention and is self-explanatory.

The error messages given could be, for example:

Error Message 1

‘Socket’ error message

Line fault

Line busy, select another store and

Error Message 2

Data incompatible with store

Line busy

Line fault

It is also envisaged that instead of delivering the trading request to the broker by inputting the actual data, the customer could input the data by scanning a barcode, whether the barcode is the barcode of an existing product or service that the customer has in his or her possession, a barcode in a catalogue or indeed any other suitable storage of barcodes that may be provided. For example, the customer computer could have a series of barcodes already stored which could be identified either by a simple click operation of a mouse or similar system. However, in the event of the customer using a scanner, the scanner could, for example, be incorporated into a phone handset which is directly incorporated into the communication system.

A virtual supermarket could be visited from the customer's home with barcodes downloaded for items required. The possibilities are endless.

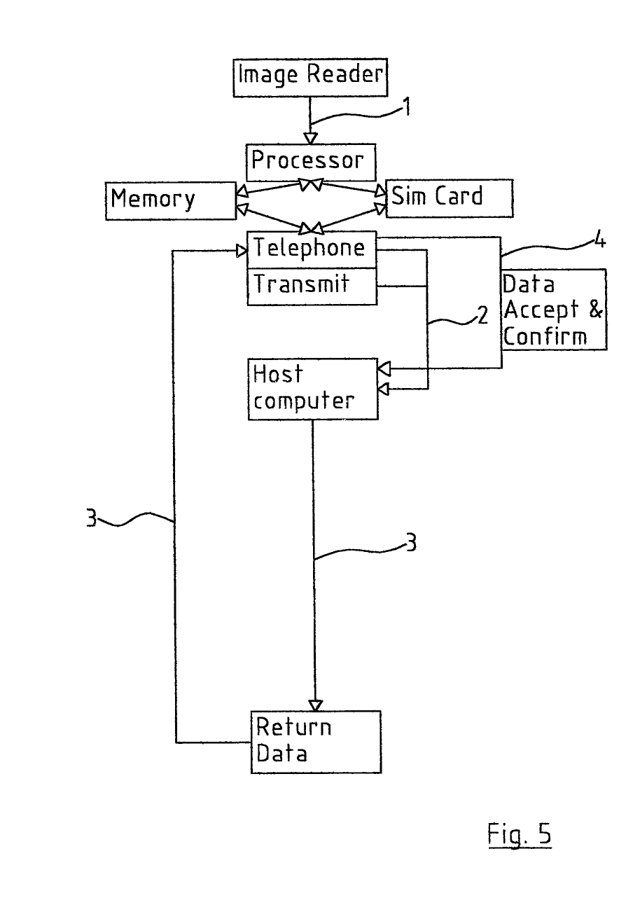

Referring now briefly to FIGS. 5 to 8, there is shown, in a different ways, methods of carrying out the present invention. To appreciate the layout of the various different tasks, FIG. 5 shows how the shopping, as previously described would be carried out. The various steps are laid out simply and identified sequentially. Thus, for example, in FIG. 5, there is illustrated how various barcodes would be scanned and then downloaded to the host computer in step 2, which host computer is the term used now for the broker computer and then the various steps carried out by the broker computer are illustrated by step 3. Essentially, the steps have now been divided so that the general functionality is explained, rather than each individual step. In other words, step 3 shows all the activities of the broker, then step 4 shows how the customer accepts the quotation and downloads all the information to the host computer.

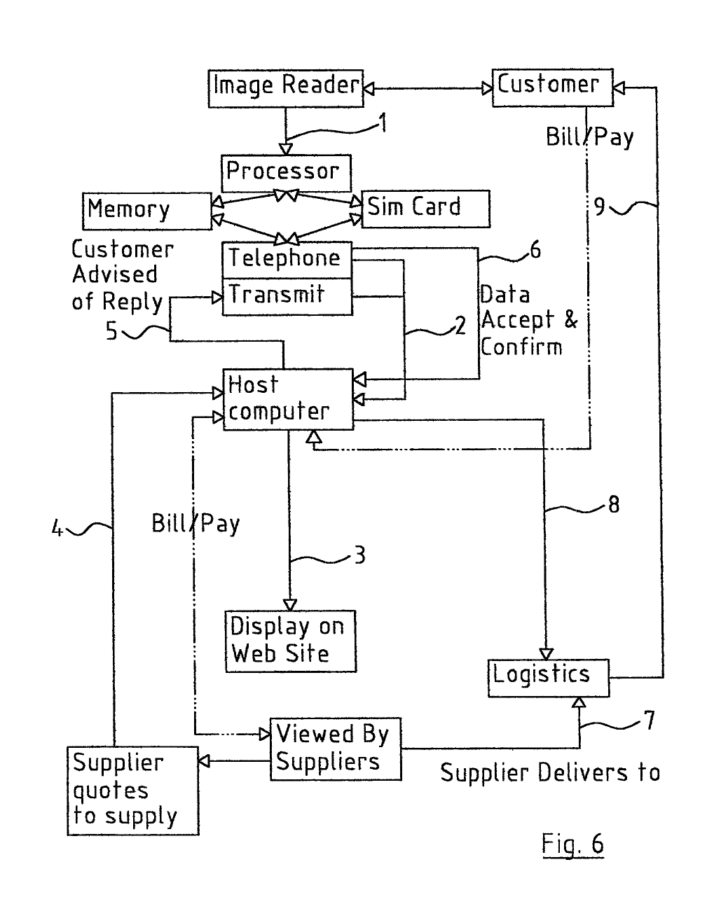

Referring now to FIG. 6, there is shown, in substantially the same way, how a more complex goods ordering task would be carried out in industry such as in a factory. In factory procurement, obviously there is more problems and tasks required. There is also then the further logistical tasks and these are laid out clearly. Again, this can be easily seen and does not require any further explanation.

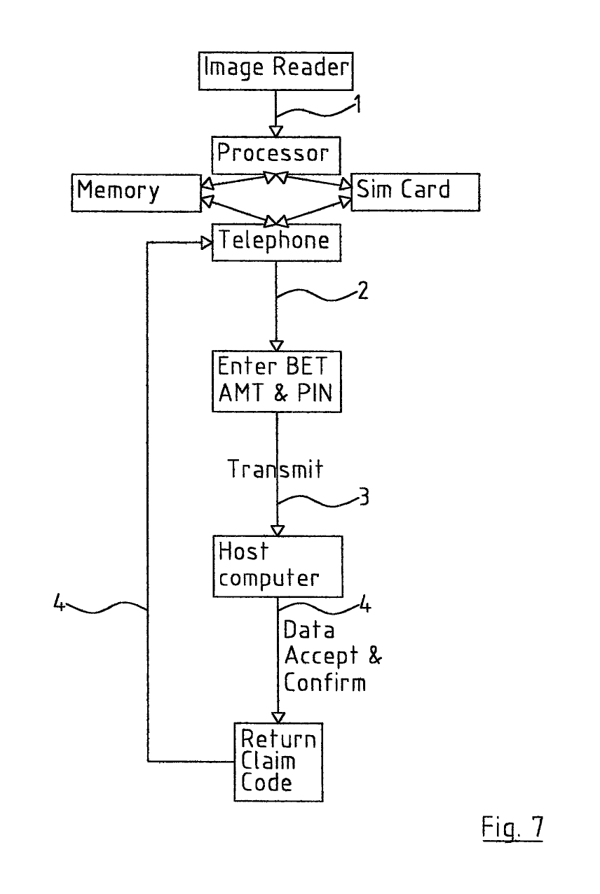

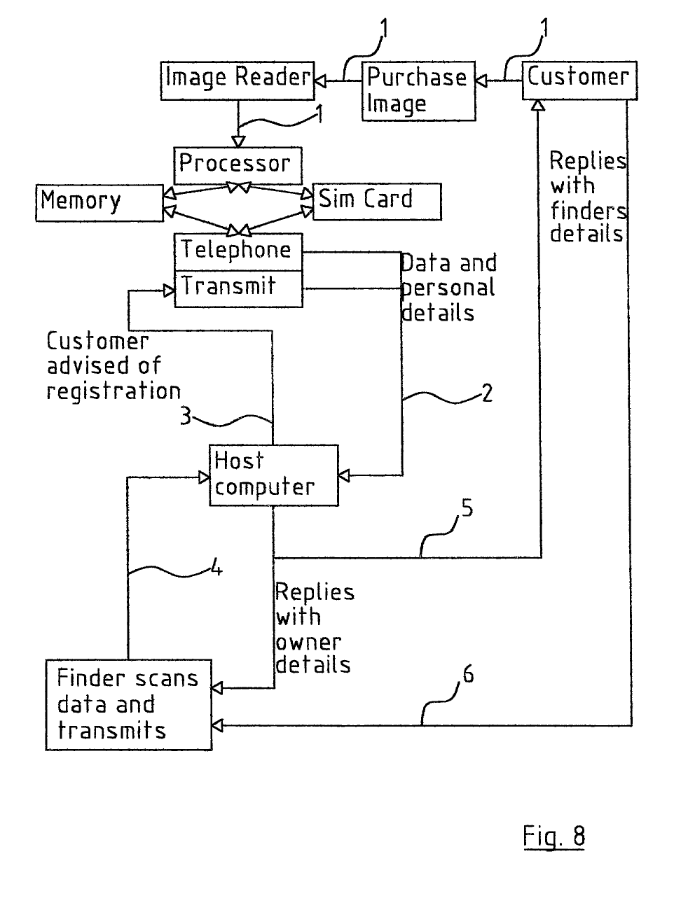

However, a different situation arises, as illustrated in FIG. 7, where a customer wishes to bet, for example, on a horse race. In wagering, it is important for the customer to have the wager accepted from some third party unconnected with the customer. Similarly, in FIG. 8, there is shown how goods which have been lost or found could be handled using the broker or host computer according to the invention.

It will be appreciated that the second step of the flow diagram can take place at any stage of the process.

Certain rules may be agreed between a customer and a broker as to the manner in which a broker obtains quotations. For example, a customer may have a rule whereby quotations are always to be taken from a preferred merchant unless the quotation of another merchant is lower by a specified amount such as 10% of the price. Generally, the rule may be such that for a transaction list of groceries, the customer may specify that merchant who gives the lowest overall price for the full transaction list be used. Further, various ways of accepting the quotations may be provided such as, for example, the customer computer may accept the quotation and download the transaction list to the broker and when the broker has confirmed payment details and shipping arrangements with the merchant computer, the broker computer may download this information to the customer computer prior to confirming the transaction. As mentioned already, various payment systems may be used.

It is envisaged that the broker computer according to the present invention will have means for receiving an initial transaction request or shopping list from the customer computer and for carrying out its various functions, as similarly will a customer computer. It is envisaged that a computer program comprising computer instructions for causing the computer to carry out the functions of the broker computer, the merchant computer and the customer computer, may be provided. Such a computer program may also be provided as program instructions which, when loaded in the computer, constitutes the means for carrying out the various functions of the computers. Such a computer program may be embodied in a record medium, in a computer memory, in a read only memory, or may indeed be carried on an electrical carrier signal.

In this specification, the terms “comprise”, “comprises” and “comprising” are used interchangeably with the terms “include”, “includes” and “including”, and are to be afforded the widest possible interpretation and vice versa.

The invention is not limited to the embodiments hereinbefore described which may be varied in both construction and detail within the scope of the claims.

1. A method of carrying out a transaction in goods and/or services between a customer and a merchant in a trading system including a communications network connecting a plurality of merchant computers; a plurality of customer computers; and at least one broker computer comprising the steps of:
the customer computer sending a list of preferred merchants to the broker computer;
the customer computer sending an initial trading request to the broker computer;
the broker computer sending the initial trading request to each merchant computer with a quotation request;
the merchant computer sending the quotation back to the broker computer;
the broker computer preparing a proposed trading request from the quotations for the preferred merchants; and
the broker computer downloading the proposed trading request to the customer.

2. A method as claimed in claim 1, in which:
the customer computer receives the proposed trading request;
the customer computer displays the proposed trading request;
the customer computer prepares a transaction list from the proposed trading request; and
the customer computer sends the relevant portion of the transaction list to the merchant computer.

3. A method as claimed in claim 1, in which:
the customer computer receives the proposed trading request;
the customer computer displays the proposed trading request;
the customer computer prepares a transaction list from the proposed trading request;
the customer computer sends the transaction list to the broker computer; and
the broker computer transmits the relevant portion of the transaction list to the merchant computer.

4. A method as claimed in claim 1, in which:
the customer computer receives the proposed trading request;
the customer computer displays the proposed trading request;
the customer computer prepares a transaction list from the proposed trading request;
the customer computer sends the transaction list to the broker computer;
the broker computer transmits the relevant portion of the transaction list to the merchant computer;
the merchant computer transmits acceptance of the order, delivery details and a payment request to the broker computer;
the broker computer confirms completion to the merchant computer; and
the broker computer confirms payment to the merchant computer.

5. A method as claimed in claim 4, in which, prior to transmitting acceptance of the order, the broker computer transmits merchant computer acceptance, delivery and payment details to the customer computer and on receiving confirmation from the customer computer, transmits the acceptance to the merchant computer.

6. A method as claimed in claim 1, in which:
the customer computer receives the proposed trading request;
the customer computer displays the proposed trading request;
the customer computer prepares a transaction list from the proposed trading request;
the customer computer sends the transaction list to the broker computer;
the broker computer transmits the relevant portion of the transaction list to the merchant computer;
the merchant computer transmits acceptance of the order, delivery details and a payment request to the broker computer;
the broker computer confirms completion to the merchant computer;
the broker computer confirms payment with the customer computer; and
the broker computer confirms payment to the merchant computer.

7. A method as claimed in claim 6, in which prior to transmitting acceptance of the order, the broker computer transmits merchant computer acceptance, delivery and payment details to the customer computer and on receiving confirmation from the customer computer, transmits the acceptance to the merchant computer.

8. A method of carrying out a transaction in goods and/or services between a customer and a merchant in a trading system including a communications network connecting a plurality of merchant computers; a plurality of customer computers; and at least one broker computer comprising the steps of:
the customer computer downloads the list of preferred merchants to the broker computer; and the broker computer stores, in a merchant database, a list of preferred merchants for each customer computer; and on the customer computer desired to carry out a transaction, the steps are performed of:
the customer computer sending a list of preferred merchants to the broker computer;
the customer computer sending an initial trading request to the broker computer;
the broker computer sending the initial trading request to each merchant computer with a quotation request;
the merchant computer sending the quotation back to the broker computer;
the broker computer preparing a proposed trading request from the quotations for the preferred merchants; and
the broker computer downloading the proposed trading request to the customer.

9. A method as claimed in claim 8, in which:
the customer computer receives the proposed trading request;
the customer computer displays the proposed trading request;
the customer computer prepares a transaction list from the proposed trading request; and
the customer computer sends the relevant portion of the transaction list to the merchant computer.

10. A method as claimed in claim 8, in which:
the customer computer receives the proposed trading request;
the customer computer displays the proposed trading request;
the customer computer prepares a transaction list from the proposed trading request;
the customer computer sends the transaction list to the broker computer; and
the broker computer transmits the relevant portion of the transaction list to the merchant computer.

11. A method as claimed in claim 8, in which:
the customer computer receives the proposed trading request;
the customer computer displays the proposed trading request;
the customer computer prepares a transaction list from the proposed trading request;
the customer computer sends the transaction list to the broker computer;
the broker computer transmits the relevant portion of the transaction list to the merchant computer;
the merchant computer transmits acceptance of the order, delivery details and a payment request to the broker computer;
the broker computer confirms completion to the merchant computer; and
the broker computer confirms payment to the merchant computer.

12. A method as claimed in claim 11, in which prior to transmitting acceptance of the order, the broker computer transmits merchant computer acceptance, delivery and payment details to the customer computer and on receiving confirmation from the customer computer, transmits the acceptance to the merchant computer.

13. A method as claimed in claim 8, in which:
the customer computer receives the proposed trading request;
the customer computer displays the proposed trading request;
the customer computer prepares a transaction list from the proposed trading request;
the customer computer sends the transaction list to the broker computer;
the broker computer transmits the relevant portion of the transaction list to the merchant computer;
the merchant computer transmits acceptance of the order, delivery details and a payment request to the broker computer;
the broker computer confirms completion to the merchant computer;
the broker computer confirms payment with the customer computer; and
the broker computer confirms payment to the merchant computer.

14. A method as claimed in claim 13, in which prior to transmitting acceptance of the order, the broker computer transmits merchant computer acceptance, delivery and payment details to the customer computer and on receiving confirmation from the customer computer, transmits the acceptance to the merchant computer.

15. A method as claimed in claim 8, in which the preferred merchants are stored in order of customer preference.

16. A method as claimed in claim 15, in which the broker computer prepares the proposed trading request having regard to pre-established rules agreed with the customer.

17. A broker computer in a trading system comprising a communications network connecting a plurality of merchant computers and a plurality of customer computers comprising:
means for receiving an initial trading request from a customer computer;
means for sending the initial trading request to one or more merchant computers with a quotation request;
means for receiving quotations from the merchant computer;
means for preparing a proposed trading request from the quotations; and
means for downloading the proposed trading request to the customer computer.

18. A computer program comprising program instructions which when loaded into a computer, constitute the means of claim 17.

19. A computer program as claimed in claim 18, embodied in a record medium.

20. A computer program as claimed in claim 18, embodied in a computer memory.

21. A computer program as claimed in claim 18, embodied in a read only memory.

22. A computer program as claimed in claim 18, carried on an electrical carrier signal.

23. A broker computer as claimed in claim 17, comprising:
means for storing in a merchant database, a list of preferred merchants for each customer;
means for retrieving the list of preferred merchants on receiving the initial trading request; and
means for sending the quotation request to the preferred merchant computers.

24. A computer program comprising program instructions which when loaded into a computer, constitute the means of claim 23.

25. A broker computer as claimed in claim 17, comprising:
means for receiving a transaction list from a customer computer; and
means for using the transaction list to complete the transaction with the merchant computer for the customer computer.

26. A computer program comprising program instructions which when loaded into a computer, constitute the means of claim 25.

27. A broker computer as claimed in claim 25, comprising:
means for storing in a merchant database, a list of preferred merchants for each customer;
means for retrieving the list of preferred merchants on receiving the initial trading request; and
means for sending the quotation request to the preferred merchant computers.

28. A customer computer for use in a trading system comprising a communications network connecting a broker computer and a plurality of merchant computers comprising:
means for downloading an initial trading request to the broker computer with a quotation request;
means, on receiving the quotation request as a proposed trading request from the broker computer, to prepare a transaction list;
means for sending the transaction list to the broker computer; and
means for completing the transaction.

29. A computer program comprising program instructions which when loaded into a computer, constitute the means of claim 28.

30. A computer program as claimed in claim 29, embodied in a record medium.

31. A computer program as claimed in claim 29, embodied in a computer memory.

32. A computer program as claimed in claim 29, embodied in a read only memory.

33. A computer program as claimed in claim 29, carried on an electrical carrier signal.

34. A customer computer as claimed in claim 28, comprising:
means for storing in a merchant database, a list of preferred merchants for each customer;
means for retrieving the list of preferred merchants on receiving the initial trading request; and
means for sending the quotation request to the preferred merchant computers.

35. A computer program comprising program instructions which when loaded into a computer, constitute the means of claim 34.

36. A customer computer as claimed in claim 28, comprising:
means for receiving a transaction list from a customer computer; and
means for using the transaction list to complete the transaction with the merchant computer for the customer computer.

37. A computer program comprising program instructions which when loaded into a computer, constitute the means of claim 36.

38. A customer computer as claimed in claim 36, comprising:
means for storing in a merchant database, a list of preferred merchants for each customer;
means for retrieving the list of preferred merchants on receiving the initial trading request; and
means for sending the quotation request to the preferred merchant computers.
